(19) United States
(12) Patent Application Publication
(10) Pub. No.: US 2026/0311325 A1
(43) Pub. Date: Oct. 8, 2026

(54) REAL-TIME ADEQUACY ASSESSMENT OF HUMAN BIOPSY SAMPLE

(71) Applicant: Kendall Square Laboratories, Inc., North Reading, MA (US)

(72) Inventor: Vijaya Kolachalama, Weston, MA (US)

(73) Assignee: Kendall Square Laboratories, Inc., North Reading, MA (US)

(21) Appl. No.: 19/463,809

(22) Filed: Jan. 29, 2026

Related U.S. Application Data
(60) Provisional application No. 63/751,739, filed on Jan. 30, 2025.

(51) Int. Cl. G06T 7/00

(52) U.S. Cl. CPC G06T 7/0012; G06T 2207/20081; G06T 2207/30024

(57) ABSTRACT

A method for assessing the adequacy of a biopsy sample is provided. The method includes generating an image of a biopsy sample. The method includes providing the image of the biopsy sample to an evaluation engine. The method includes receiving a report from the evaluation engine, wherein the report comprises an indication of the adequacy of the biopsy sample. The method includes making a determination, based on the report, on whether the biopsy sample is adequate.

### CROSS REFERENCE TO RELATED APPLICATION

This application claims priority to U.S. Provisional Application No. 63/751,739, filed Jan. 30, 2025, the entire disclosure of which is incorporated herein by reference.

### BACKGROUND

A biopsy is a diagnostic procedure in which a tissue sample is collected to assess for disease, with adequacy determined by the presence of sufficient target structures specific to the organ of interest, such as glomeruli and tubular structures in the case of kidney biopsies. Biopsy inadequacy occurs when the sample lacks these critical features, limiting the pathologist's ability to make a diagnosis. Inadequate human biopsy samples are an increasingly common challenge. Many institutions lack the resources to have a pathologist available for real-time evaluation of biopsy samples, leading to a higher incidence of inadequate specimens. Sample inadequacy not only forces clinicians to repeat procedures but also places patients at risk of getting an incomplete or delayed diagnosis. This is more pronounced now that radiologists or other experts handle most of these procedures in many hospitals.

### SUMMARY

Many institutions lack the resources to have a pathologist on hand for real-time evaluations of biopsy samples, but it is otherwise difficult to assess the adequacy of specimens in real time. Institutions need a quick, cost-effective option to assess the adequacy of specimens, e.g., to verify the presence of enough kidney cortex material, or in the case of the liver, a sufficient number of complete portal tracts (CPTs). A pilot study (see https://www.kireports.org/article/S2468-0249(21)01550-3/fulltext, and also attached as an appendix) has shown that the rate of kidney biopsy misses has been climbing, which underscores the urgency.

Certain aspects of the disclosure and their embodiments may provide solutions to these or other challenges. Embodiments provide methods and devices to provide real-time adequacy assessment of human biopsy samples. For example, in one possible workflow, a user may provide an image to an application (or “App”) via an App interface. The App may then provide the image to an evaluation engine (e.g., running on a server) which processes the image. Such images may be provided by a smartphone or other available image-provisioning device, such as by the user using the smartphone to take a photo, using an external device that interfaces with the smartphone, or otherwise. The processing may comprise using a machine learning (ML) and/or artificial intelligence (AI) model that can evaluate images of biopsy samples. The result of the processing may include a report summarizing the key findings relevant to adequacy such as the dimensions of the biopsy sample (e.g., length and width/thickness), and may also identify components on the biopsy sample such as the cortex, medulla, fat capsule, and other non-relevant regions. Use of such a workflow may result in significant potential in terms of immediate, on-site adequacy checks, which can dramatically lower repeated procedures.

Note that the disclosure here at times refers to kidney biopsies as a particular example within the scope of disclosed embodiments. The issue addressed here regarding adequacy of biopsy samples, and the embodiments to assess this adequacy, is not limited to the kidney, but rather pertains to several organ systems in the body. Accordingly, embodiments disclosed herein are applicable to other types of biopsy samples from other organ systems (e.g., liver, lung, skin, etc.).

Certain embodiments may provide one or more of the following technical advantage(s). One advantage of certain embodiments is reducing re-biopsy rates.

Other advantages may be readily apparent to one having skill in the art. Certain embodiments may have none, some, or all the recited advantages.

According to a first aspect, a method for assessing the adequacy of a biopsy sample is provided. The method includes generating an image of a biopsy sample. The method includes providing the image of the biopsy sample to an evaluation engine. The method includes receiving a report from the evaluation engine. The report comprises an indication of the adequacy of the biopsy sample. The method includes making a determination, based on the report, on whether the biopsy sample is adequate.

According to a second aspect, a method for assessing the adequacy of a biopsy sample is provided. The method includes receiving an image of a biopsy sample. The method includes processing the image of the biopsy sample using a machine learning (ML) and/or artificial intelligence (AI) based model to generate a report. The report comprises an indication of the adequacy of the biopsy sample. The method includes providing the report to a user.

According to a third aspect, a computing device for assessing the adequacy of a biopsy sample is provided. The computing device includes processing circuitry configured to generate an image of a biopsy sample. The computing device includes processing circuitry configured to provide the image of the biopsy sample to an evaluation engine. The computing device includes processing circuitry configured to receive a report from the evaluation engine. The report comprises an indication of the adequacy of the biopsy sample. The computing device includes processing circuitry configured to make a determination, based on the report, on whether the biopsy sample is adequate.

According to a fourth aspect, a computing device for assessing the adequacy of a biopsy sample is provided. The computing device includes processing circuitry configured to receive an image of a biopsy sample. The computing device includes processing circuitry configured to process the image of the biopsy sample using a machine learning (ML) and/or artificial intelligence (AI) based model to generate a report. The report comprises an indication of the adequacy of the biopsy sample. The computing device includes processing circuitry configured to provide the report to a user.

According to a fifth aspect, a non-transitory computer readable medium is provided. The non-transitory computer readable medium contains instructions which, when executed, cause a processor to perform the steps of any one of the embodiments of the first and second aspects.

### BRIEF DESCRIPTION OF THE FIGURES

The accompanying drawings, which are incorporated herein and form part of the specification, illustrate various embodiments.

FIG. 1 illustrates a system according to an embodiment.

FIG. 2 is a flowchart illustrating a process according to an embodiment.

FIG. 3 is a flowchart illustrating a process according to an embodiment.

### DETAILED DESCRIPTION

Some of the embodiments contemplated herein will now be described more fully with reference to the accompanying drawings. Embodiments are provided by way of example to convey the scope of the subject matter to those skilled in the art.

Embodiments provide for a smartphone-based tool that uses machine learning or artificial intelligence to quickly gauge the adequacy of biopsy samples (e.g., kidney biopsy samples) directly from smartphone photos. Other embodiments provide for other methods of uploading images, such as via a digital camera, and may be used on tablets, laptops, computers, and other electronic devices. A pilot study has indicated that embodiments can accurately identify and measure the cortical portion of a kidney biopsy, and embodiments are also applicable to other types of biopsies.

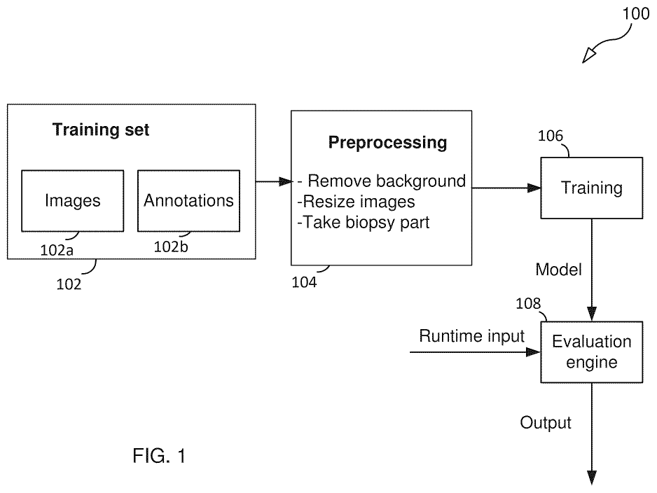

FIG. 1 illustrates a system according to an embodiment. System 100 can be divided conceptually into training time—when a ML/AI model is trained—and runtime, when the model is used to evaluate images in real time. As part of training, training set 102 is provided, which may include images 102a and annotations 102b. In the case of kidney biopsies, the images 102a may include kidney images and the annotations 102b may be cortex annotations. Alternatively or in addition to annotating for biopsy regions of interest, annotations 102b may include text associated with the image such as free text explanations (e.g., a textual evaluation and/or medical report associated with the image). The training set 102 may comprise data from multiple sources, e.g., one or more hospitals or other types of clinical settings. The images 102a may come with annotations 102b, or the annotations 102b may be provided later and/or come from another source. While this disclosure uses the term “image” primarily when referring to the input, it should be understood throughout this disclosure that the input of the model (at training time and/or runtime) may also include a video. In some cases, the model may be trained on the video and take a video at runtime, in other cases the video may be processed to generate a series of still images that are used for training and runtime. In a pilot study, 100 images were used in the training set, but the training set 102 may include fewer images than this, or may include more, and in some embodiments may include substantially more. The images may be taken under similar conditions, such as the camera and needle type, or may cover a range of different conditions, e.g., different cameras, lenses and needle types.

Prior to training, preprocessing 104 may be performed on the training set 102. This may include, for example, one or more of: removing image background, re-sizing images, and extracting the relevant biopsy region(s) of interest. Other preprocessing steps may be taken to better prepare the training set 102 for training, e.g., to improve the model performance and/or make training more efficient. For example, background variability can impact the results. Accordingly, algorithms that account for lighting variations or variable backgrounds (e.g., a biopsy placed on a petri dish or a biopsy placed on ice), may be used here. After preprocessing 104, training 106 may occur. This may include ML/AI techniques, such as training a deep neural network (e.g., a large language model (LLM) and/or transformer based architecture) using the training set 102. Other types of models other than deep neural networks may also be used.

The output of training 106 is a model, which may be used in the evaluation engine 108. Evaluation engine 108 receives runtime input and generates an output. The runtime input may include an image or short video (e.g., a kidney biopsy image uploaded from a user's smartphone or camera). The output may include an indication of the adequacy of the biopsy sample based on the image or video. For example, the output may indicate a cortex annotation (for a kidney biopsy image or video) and a percentage of cortex area relative to the overall biopsy area. The output may also include a heatmap or highlighted view that may be presented to the user. The output may be different according to the organ system being biopsied. For example, factors such as size of the biopsy, extent of fragmentation, number of portal tracts, and location are some factors that can be estimated to evaluate the adequacy of a liver biopsy sample. For other types of organ systems, other factors may be used that are relevant to the given organ system.

The output may provide a real-time indication to a user, such that a user is able to assess the adequacy of the biopsy sample while the patient is still present. In embodiments, the output may be provided nearly instantaneously, in under one minute, in under two minutes, in under 5 minutes, and/or in under 10 minutes from the time of providing the image of the biopsy sample. If the biopsy sample turns out not to be adequate, another biopsy sample can be taken immediately. If it is adequate, the biopsy sample can be further processed, e.g., at another location.

In some embodiments, a user may use an application (or “App”) when performing this workflow. The application may alert a user, for example, if a given image is not of sufficient quality to proceed (e.g., the image is too blurry, or otherwise has issues that may present complications to evaluation), allowing the user to take another image such as by using a smartphone's camera (possibly with a lens attachment) or an external attachment or other device capable of generating an image of the biopsy sample. The application may process the image before sending it to the evaluation engine, such as by using imaging techniques to enhance the image. The application may also allow a user to crop the image, e.g., to select a particular area of interest. The application may be smartphone based and/or web based. In some embodiments, a user may initially begin by using a smartphone application to take an image of the biopsy sample and submit it for evaluation, and then switch to another device, e.g., using a web-based interface to view the results.

The model may be trained in one environment and then provided to an evaluation engine that runs in the same environment or in a different environment. For example, the model may be trained in the cloud, on one or more servers, or even in a local environment such as a personal computer or even the smartphone itself. Typically, training will be more resource intensive than evaluations at inference, and more compute resources may be supplied during training. The evaluation engine may run in the cloud (the same cloud as the model was trained in or a different one), on one or more servers, or even in a local environment such as a personal computer or the smartphone itself. The App referenced above provides an interface to the evaluation engine. The user may access the App, provide input to the evaluation engine through the App, and view results on the App. The App may require login via secure credentials, and may contain historical data (e.g., prior reports from the evaluation engine) that can be reviewed. The App may store data encrypted and may also store data locally (such as on the device running the App) or remotely (such as in the cloud or elsewhere). The App may also handle all information it receives securely, such as by requiring authorized access and by using encryption, and the App may also process and store data in a way to further promote user or patient privacy.

The App may be referred to as a “front end,” interfacing with the user, and the evaluation engine may be referred to as the “back end.” In some embodiments the App may run in the same environment as the evaluation engine (e.g., both run on a smartphone or personal computer), but typically the App and evaluation engine would run in separate environments. The App may be accessed via a web-based interface and may be compatible with different devices and operating systems. In some embodiments, the App may permit a user to submit multiple images of a biopsy sample and estimate the results to get an averaged or overall adequacy score.

In the pilot study noted above, 100 images were used as part of training, and these were annotated by a group of nephropathologists. The images were based on biopsy samples taken with 16G needles using an iPhone 13 Pro camera. Each of the 100 training images was re-sized to 256×256 pixels, and the corresponding annotations were also re-sized to match these dimensions. The image-annotation pairs were processed using MedSAM, a model for segmenting medical images.

The pilot study and subsequent data collection demonstrate that embodiments assess adequacy of a biopsy sample (e.g., by estimating the overall percentage of cortex) quickly and accurately without expensive add-ons or a complicated setup. Additional equipment (e.g., lenses, or other external imaging devices) may be used in some embodiments but are not required. Furthermore, embodiments can handle diverse images (e.g., including images with a partial or near-complete cortex) in real time.

In certain embodiments, model training can involve training the biopsy images with text annotations such as captions or text summaries or medical reports. The training process can be augmented with a language model, such as a commercially available LLM. Multi-modal models (which are capable of handling both text and images, among potentially other sources of data such as audio) are types of LLMs which may be used in certain embodiments. For example, the LLM may be used to normalize the text annotations and/or serve as a base model which may be fine-tuned using the training set. Once the training is performed, the model can take in the biopsy image as the input and provide a detailed text summary of biopsy adequacy.

In the context of kidney biopsy, embodiments may estimate the percentage of cortex area relative to the overall biopsy area from a 2-dimensional image. Alternatively, or in addition, embodiments may use three-dimensional features to enable more accurate estimation of tissue volume. This may be a result of improved image capture, e.g., from advanced smartphone imaging technologies, from relying on multiple images at different vantage points, or from other techniques to capture 3-dimensional features.

In the context of kidney biopsy, embodiments emphasize the cortical region and calculate the cortex percentage relative to the entire biopsy sample. However, sampling cortex without glomeruli can occur, and such biopsies may still be deemed inadequate. Embodiments therefore may incorporate advanced image analysis techniques capable of identifying and counting glomeruli within the cortical region, focusing on perfused glomeruli, which are clinically significant. These features may be used by the model for evaluating an image of a biopsy sample.

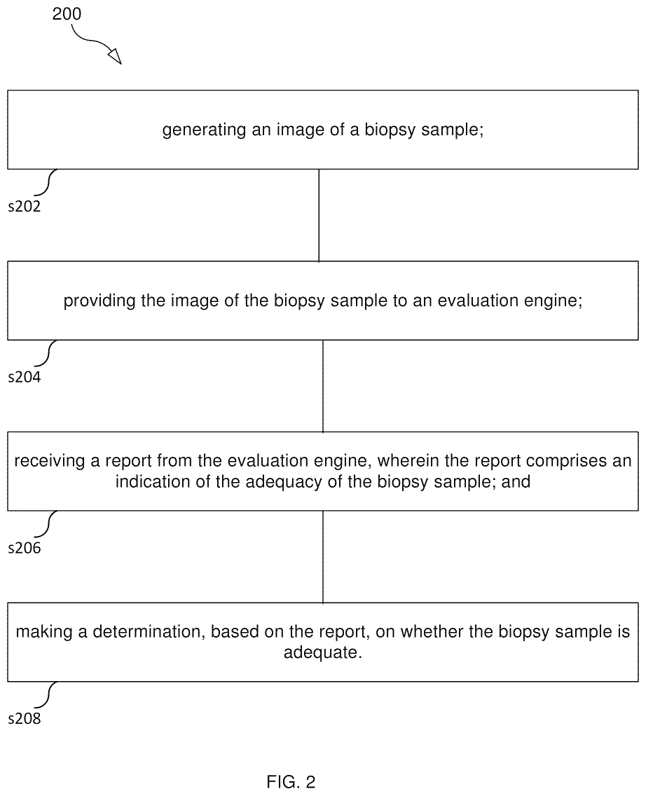

FIG. 2 is a flowchart illustrating a process 200 method for assessing the adequacy of a biopsy sample, according to an embodiment. Process 200 may begin in step s202.

Step s202 comprises generating an image of a biopsy sample.

Step s204 comprises providing the image of the biopsy sample to an evaluation engine.

Step s206 comprises receiving a report from the evaluation engine, wherein the report comprises an indication of the adequacy of the biopsy sample.

Step s208 comprises making a determination, based on the report, on whether the biopsy sample is adequate.

In some embodiments, the method further includes, as a result of making a determination, based on the report, on whether the biopsy sample is adequate, determining whether a further biopsy sample is needed. In some embodiments, the report is received after providing the image of the biopsy sample to an evaluation engine within a few minutes (e.g., two minutes).

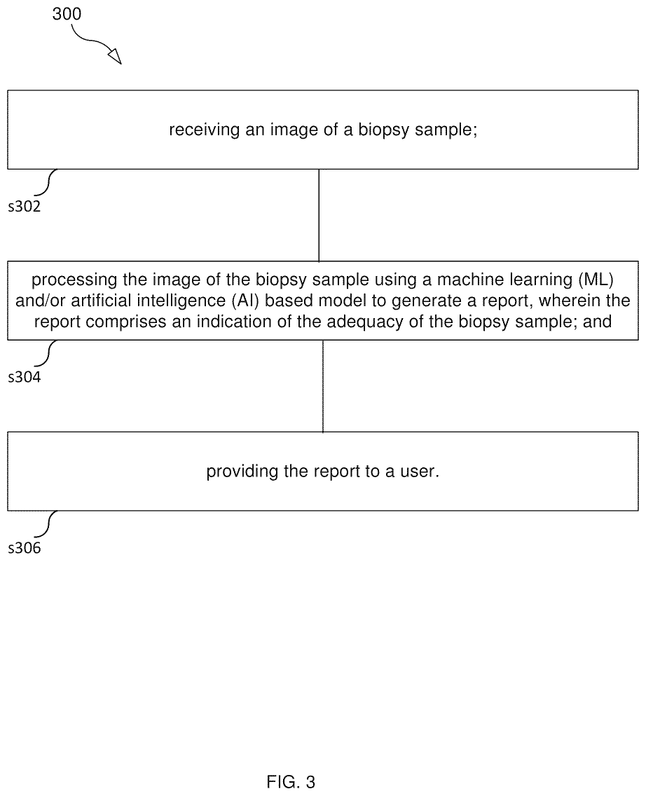

FIG. 3 is a flowchart illustrating a process 300 method for assessing the adequacy of a biopsy sample, according to an embodiment. Process 300 may begin in step s#02.

Step s302 comprises receiving an image of a biopsy sample.

Step s304 comprises processing the image of the biopsy sample using a machine learning (ML) and/or artificial intelligence (AI) based model to generate a report, wherein the report comprises an indication of the adequacy of the biopsy sample.

Step s306 comprises providing the report to a user.

In some embodiments, the report comprises information on one or more isolated elements of the biopsy sample including a cortex. In some embodiments, the report comprises one or more biopsy-level metrics including a percentage of the cortex in relation to the overall biopsy sample. In some embodiments, the ML and/or AI model comprises a deep neural network. In some embodiments, the report is provided to the user after receiving the image of the biopsy sample within a few minutes (e.g., two minutes).

In certain embodiments, some or all the functionality described herein may be provided by processing circuitry executing instructions stored on in memory, which in certain embodiments may be a computer program product in the form of a non-transitory computer-readable storage medium. In alternative embodiments, some or all the functionalities may be provided by the processing circuitry without executing instructions stored on a separate or discrete device-readable storage medium, such as in a hard-wired manner. In any of those embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device, and/or by end users and a wireless network generally.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the description of the embodiments does not constrain this disclosure. Other changes, substitutions, and alterations are possible without departing from the scope of this disclosure.

### EMBODIMENTS

### Group A Embodiments

A1. A method for assessing the adequacy of a biopsy sample, the method comprising: generating an image of a biopsy sample;
providing the image of the biopsy sample to an evaluation engine;
receiving a report from the evaluation engine, wherein the report comprises an indication of the adequacy of the biopsy sample; and
making a determination, based on the report, on whether the biopsy sample is adequate.

A2. The method of embodiment A1, further comprising, as a result of making a determination, based on the report, on whether the biopsy sample is adequate, determining whether a further biopsy sample is needed.

A3. The method of embodiment A1, wherein the report is received after providing the image of the biopsy sample to an evaluation engine within two minutes.

A4. The method of embodiment A1, wherein the report includes a textual description of the biopsy sample (e.g., a textual summary or medical analysis).

### Group B Embodiments

B1. A method for assessing the adequacy of a biopsy sample, the method comprising:
receiving an image of a biopsy sample;
processing the image of the biopsy sample using a machine learning (ML) and/or artificial intelligence (AI) based model to generate a report, wherein the report comprises an indication of the adequacy of the biopsy sample; and
providing the report to a user.

B2. The method of embodiment B1, wherein the report comprises information on one or more isolated elements of the biopsy sample including a cortex.

B3. The method of embodiment B2, wherein the report comprises one or more biopsy-level metrics including a percentage of the cortex in relation to the overall biopsy sample.

B4. The method of embodiment B1, wherein the ML and/or AI model comprises a deep neural network.

B5. The method of embodiment B1, wherein the report is provided to the user after receiving the image of the biopsy sample within two minutes.

B6. The method of embodiment B1, wherein the report includes a textual description of the biopsy sample (e.g., a textual summary or medical analysis).

### Group C Embodiments

C1. A computing device for assessing the adequacy of a biopsy sample, the computing device comprising:
processing circuitry configured to:
generate an image of a biopsy sample;
provide the image of the biopsy sample to an evaluation engine;
receive a report from the evaluation engine, wherein the report comprises an indication of the adequacy of the biopsy sample; and
make a determination, based on the report, on whether the biopsy sample is adequate.

C2. The computing device of embodiment C1, wherein the processing circuitry is further configured to perform the steps of any one of embodiments A2-A4.

### Group D Embodiments

D1. A computing device for assessing the adequacy of a biopsy sample, the computing device comprising:
processing circuitry configured to:
receive an image of a biopsy sample;
process the image of the biopsy sample using a machine learning (ML) and/or artificial intelligence (AI) based model to generate a report, wherein the report comprises an indication of the adequacy of the biopsy sample; and
provide the report to a user.

D2. The computing device of embodiment D1, wherein the processing circuitry is further configured to perform the steps of any one of embodiments B2-B6.

### Group E Embodiments

E1. A non-transitory computer readable medium containing instructions which, when executed, cause a processor to perform the steps of any one of embodiments A1-A4 and B1-B6.

While various embodiments are described herein, they have been presented by way of example only, and not limitation. Thus, the breadth and scope of this disclosure should not be limited by any of the above-described exemplary embodiments. Moreover, any combination of the above-described embodiments in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for assessing the adequacy of a biopsy sample, the method comprising:
generating an image of a biopsy sample;
providing the image of the biopsy sample to an evaluation engine;
receiving a report from the evaluation engine, wherein the report comprises an indication of the adequacy of the biopsy sample; and
making a determination, based on the report, on whether the biopsy sample is adequate.

2. The method of claim 1, further comprising, as a result of making a determination, based on the report, on whether the biopsy sample is adequate, determining whether a further biopsy sample is needed.

3. The method of claim 1, wherein the report is received after providing the image of the biopsy sample to an evaluation engine within two minutes.

4. The method of claim 1, wherein the report includes a textual description of the biopsy sample.

5. A method for assessing the adequacy of a biopsy sample, the method comprising:
receiving an image of a biopsy sample;
processing the image of the biopsy sample using a machine learning (ML) and/or artificial intelligence (AI) based model to generate a report, wherein the report comprises an indication of the adequacy of the biopsy sample; and
providing the report to a user.

6. The method of claim 5, wherein the report comprises information on one or more isolated elements of the biopsy sample including a cortex.

7. The method of claim 6, wherein the report comprises one or more biopsy-level metrics including a percentage of the cortex in relation to the overall biopsy sample.

8. The method of claim 5, wherein the ML and/or AI model comprises a deep neural network.

9. The method of claim 5, wherein the report is provided to the user after receiving the image of the biopsy sample within two minutes.

10. The method of claim 5, wherein the report includes a textual description of the biopsy sample.

11. A computing device for assessing the adequacy of a biopsy sample, the computing device comprising:
processing circuitry configured to:
generate an image of a biopsy sample;
provide the image of the biopsy sample to an evaluation engine;
receive a report from the evaluation engine, wherein the report comprises an indication of the adequacy of the biopsy sample; and
make a determination, based on the report, on whether the biopsy sample is adequate.

12. A computing device for assessing the adequacy of a biopsy sample, the computing device comprising:
processing circuitry configured to:
receive an image of a biopsy sample;
process the image of the biopsy sample using a machine learning (ML) and/or artificial intelligence (AI) based model to generate a report, wherein the report comprises an indication of the adequacy of the biopsy sample; and
provide the report to a user.
